(19) United States
(12) Patent Application Publication
(10) Pub. No.: US 2007/0227913 A1
(43) Pub. Date: Oct. 4, 2007

(54) Secure pharmacy shipping crate with temperature and humidity monitoring

(75) Inventor: Norman A. Shoenfeld, Livingston, NJ (US)

Correspondence Address: BERNHARD P. MOLLDREM, JR., 224 HARRISON STREET, SUITE 200, SYRACUSE, NY, 13202, US

(73) Assignee: S&S X-Ray Products, Inc.

(21) Appl. No.: 11/800,937

(22) Filed: May 8, 2007

Related U.S. Application Data
(63) Continuation-in-part of application No. 11/653,726, filed on Jan. 16, 2007.
Application No. 11/653,726 is a continuation-in-part of application No. 11/391,386, filed on Mar. 29, 2006.

(51) Int. Cl. E05B 49/02

(52) U.S. Cl. 206/1.5

(57) ABSTRACT

A locking shipping crate for pharmaceutical shipments monitors the temperature and/or humidity within the crate in transit to identify whether the contents are safe or compromised. A keyboard/display on the lid of the crate provides an ID code that the recipient enters into a computer web page to communicate this ID code to the shipper. If the ID code represents a safe shipment, the shipper returns an unlock code that the recipient enters to unlock the lid. If there has been a compromise, a different ID code is presented, and the shipper instead returns a message to return the crate, and denies the unlock code. A key lock may be present, with keys available only to trusted personnel.

This is a continuation-in-part of my copending U.S. patent application Ser. No. 11/653,726, filed Jan. 16, 2007, which is a continuation-in-part of my co-pending U.S. patent application Ser. No. 11/391,386, filed Mar. 29, 2006. The same are incorporated herein by reference.

### BACKGROUND OF THE INVENTION

This invention relates to containers used for shipping pharmaceuticals, especially those sensitive pharmaceuticals that can be compromised if temperature and/or humidity conditions are not properly observed during shipping. The invention is also concerned with a pharmacy shipping container that incorporates an electronic lock on a lid or door, and which can be opened by the recipient only by supplying a proper opening code or sequence.

During transit, some pharmaceutical shipments need to be kept within a critical temperature range, and if so the crate or container needs to incorporate a system for monitoring the internal temperature. In addition to temperature monitoring, some pharmaceuticals need to be monitored for humidity, and some for both temperature and humidity. Some medicaments and medical products need to be at a temperature above ambient.

For transport of pharmaceuticals, or for use of pharmaceuticals in a mobile situation, there is a need for a locking chest or crate that operates under battery power so that the pharmaceuticals can be monitored (e.g., for temperature and/or humidity) during transport. Then, if the temperature or humidity was outside the acceptable range during shipping, access can be denied to the cabinet and to the possibly tainted medication, except for specially authorized supervisory personnel.

Often it is desirable to track the temperature (and/or humidity) of the contents of the shipping chest or crate, and automatically to provide an alert warning if the temperature (or relative humidity) has been outside an acceptable range during transit.

A further need is for ensuring patient safety, i.e., to ensure any drugs that have not been kept at the proper storage conditions, e.g., having been outside of an acceptable temperature range, are not made available to patients until purity has been checked out by pharmacy staff.

The pharmaceutical industry has achieved a global reach and impact, with medicines and vaccines being shipped to all areas of the world. Many of these medicines and vaccines are temperature sensitive and have precise storage requirements. Unfortunately, during shipment the products can be subjected to extreme temperature and humidity changes, unforeseen delays during transit, especially international transit, and need for field delivery to remote points of use, several mode changes may occur. In addition, the pharmaceutical companies are subject to relentless cost pressures, so there is a need to make shipping and distribution as efficient as possible while ensuring that the products that are delivered are of consistent quality.

At the present time, most refrigerated medications are shipped in twelve-inch by twenty-four-inch insulated boxes, with ice. These can include a digital thermometer device that logs the temperature, but does not lock the box closed, and does not guarantee that any medication in the box that was subject to poor temperature control is isolated and not distributed to a patient. Some medications are shipped in a box or crate without ice, and are shipped in a refrigerated container. These boxes may have a special security tape that is intended to reveal tampering, but these are not locked containers, and there is no means included to prevent distribution of the medications if they had been subjected to adverse temperature (or humidity) conditions.

### OBJECTS AND SUMMARY OF THE INVENTION

Accordingly, it is an object of the present invention to provide a locking shipping chest or cabinet with a facility to alert the recipient and deny access if the temperature and/or humidity conditions have been outside a safe range or window.

It is another object to provide a shipping container or crate that automatically alerts the shipper if the pharmaceuticals are compromised at the time that the shipment is received.

A further object is to provide a shipping container or crate with a system providing a record of temperature conditions during shipment so as to help identify situations in the shipping process that may be causing adverse temperature conditions or other problems for the sensitive products being shipped.

Another object is to provide the electronic door lock mechanism with a key lock override that can be used, e.g., for authorized persons to obtain access to the medications in the container or crate.

A more specific object is to provide a locking shipping crate or chest which is suitable for use in shipping of pharmaceuticals in a mobile refrigerated van or refrigerated shipping container, and with its temperature monitoring facilities to maintain a record of the temperature over time during transit.

In accordance with an aspect of the present invention, a shipping crate is adapted for mobile or portable use, i.e., for transporting or shipping pharmaceutical materials, with a lid or door that incorporates a lock mechanism that is electronically controlled and which is designed to work under battery power. The lock mechanism has metering and monitoring facilities, so that the storage conditions for the pharmaceuticals can be monitored during shipping. If the temperature and/or humidity is outside of the acceptable range during shipping, the lock may automatically deny access to the recipient (but may permit access to specially authorized pharmacy personnel). This feature can prevent distribution of potentially contaminated or spoiled items. In an embodiment for this use, the crate or shipping container may be an insulated box containing ice or a box without ice intended to be transported in a refrigerated truck. The crate can have a membrane switch, i.e., keypad/display, which provides an ID code that it displays as a sequence of numbers and/or letters. The recipient enters this sequence into the shipper website to obtain an opening code sequence. If the shipment has been maintained under acceptable humidity and temperature conditions, the code sequence will permit the recipient to open the lock and access the contents of the shipping box. However, if the contents have been subjected to extreme temperatures or humidity changes, the device will provide a different ID code sequence that indicates that the materials may have been compromised. The entry of that ID code sequence into the shipper's web site will instead return instructions to return the box to the shipper, and the recipient will be denied access. After the box is returned to the shipper, the shipper can obtain an audit trail of the time versus temperature and humidity conditions, and can identify the source of the problem. The software within the crate or container includes audit trail programming for recording time of opening of shipping crate, and may also records the identity of each requesting person associated with opening(s) of the crate. The software also keeps a time record of the temperature (and/or relative humidity) inside the unit When the software determines that the temperature in a given refrigerator has varied outside of the preset limits, the system will deny access, by providing a coded sequence that corresponds to the temperature-compromised condition. This coded sequence is recognized by the shipper computer, and the latter automatically sends instructions to return the container and not to attempt opening it. The opening ID code changes with each shipment and may change at intervals, based on a security code or encryption system. The encryption software is present both in the shipping computer and in the control circuitry of the crate, as the codes generated are time sensitive. A key lock mechanism may be provided on the chest, but only authorized pharmacy personnel at the shipping site have keys, so that only authorized pharmacy personnel can open the crate. This may alternatively employ an over-ride code.

The shipping container or crate may be constructed with insulation and a provision for holding ice, or alternatively it may simply enclose a standard refrigerated shipping container. The container or crate may also be designed for use within a refrigerated shipping container or vessel, and not need its own supply of ice or other chilling material.

Software is provided for the shipper and an interactive program is embedded into the shipping crate or container. This allows the shipper to provide, via Internet, the correct opening code sequence to the receiver when the shipment is received in good order. This arrangement can also identify a compromise situation, and then send a message not to attempt to open the crate but to return same to the shipper (or to another place, as instructed). This software may also provide for automated notification of regulatory authorities when a given shipment has been compromised, so that the product codes will be available, as well as suitable product alerts, in the event that the compromised pharmaceuticals are removed from the crate and distributed. Connection may be made using a USB or other cable, or with a wireless system, e.g., Bluetooth.

The above and many other objects, features, and advantages of this invention will become apparent from the ensuing description of a selected preferred embodiment, which is to be considered in connection with the accompanying Drawing.

### BRIEF DESCRIPTION OF THE DRAWING

FIG. 1 is perspective view showing an embodiment of this invention in a locking pharmaceutical shipping crate or container.

FIG. 2 is a sectional schematic view thereof.

FIG. 3 is a plan view of the touch-screen keypad thereof.

### DETAILED DESCRIPTION OF THE PREFERRED EMBODIMENT

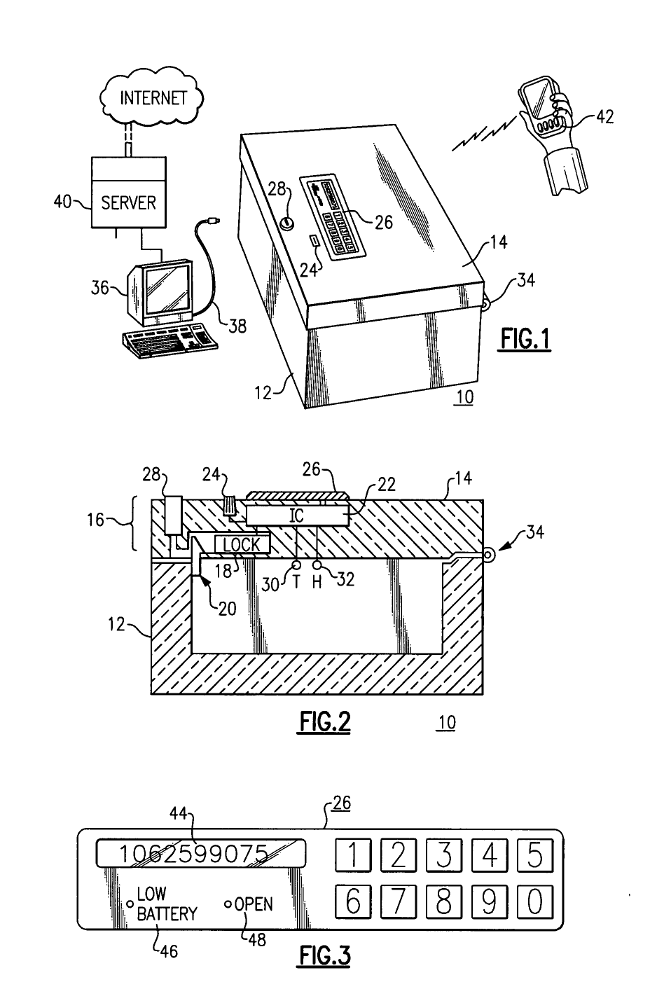

With reference to the Drawing, and initially to FIGS. 1 and 2, a pharmaceutical shipping container or crate 10 is adapted for secure shipment of medications and pharmaceuticals that need to be kept refrigerated and/or need to be kept within a temperature range or humidity range. The crate 10 has an main enclosure or body 12 and a door or lid 14. In the illustrated embodiment, the door or lid 14 closes off the top of the crate, but it is also possible to have the door mounted at the front, where it may be hinged at the right to open from the left, or hinged at the left as a right-opening door. When the door or lid is closed, an internal locking mechanism 16 holds the door or lid 14 locked and maintains compression on the door seal. In this embodiment, the lock mechanism 16 has an electronically actuated locking device 18 within the lid to engage a latch 20 when the lid is shut and to release the latch 20 when provided with an unlock code sequence, as described in more detail later. Within the lid 14 is a digital controller circuit 22 that is connected with the locking device 18, and with a USB port 24 and a touch screen display and keypad mechanism 26. The a USB port 24 allows the controller circuit 22 to be connected electrically or electronically via a network, e.g., a LAN, that makes either a wired or wireless connection with a host computer server, to be discussed later.

In FIG. 2, the lid 14 and body 12 are shown schematically. In a practical embodiment, there can be compartments for ice or other cold source, as well as insulation in the walls of the crate.

A key lock 28 is also present, permitting a trusted or authorized person to gain access to the chest and to its contents. The shipping agency, responsible for loading the crate and who may need to access a returned shipment, are provided with keys for this lock 28. Alternatively, trusted access can be by entry of special code, or by identification of a bar code or magnetically coded card, or by an RFID identification badge or card, for example. The digital controller circuit 22 includes built-in software that can maintain a log of the temperature and humidity inside the shipping crate during transit. Within the crate 10 or container are an internal temperature sensor probe 30 and a humidity sensor probe 32. In this embodiment, the controller circuit 22 is powered by an internal battery power, which may also provide power for the locking mechanism 18. Power for operating the lock mechanism 18 to unlatch the lid 14 may also be provided via the USB port 24.

As further shown in FIGS. 1 and 2, a hinge 34 is disposed at the back of the crate 10 to attach the lid 14 to the body 12.

In a typical receiving environment, i.e., at a receiving warehouse or similar facility, a computer work station terminal 36 is present, which may be connected via a USB cable 38 to the USB port 24 on the lid 14. The computer terminal 36 is also coupled, e.g., via a local server 40, to the Internet, where it can communicate with the shipper's web site to confirm safe delivery of the crate. Alternatively, the receiver can communicate wirelessly with the crate electronics and the shipper using a hand held device 42.

FIG. 3 shows one example of the touch-screen keypad device 26, here in the form of a membrane switch. A numeric display 44 at the upper left of the membrane switch shows a sequence of digits, here a ten-digit number, that is provided from the controller circuit 22. There are LED indicator lights 46 and 48, red and green, respectively, to indicate a low battery condition or open status of the crate. On the right is a pad 48 of ten touch-buttons or push-buttons, for the operator to enter a code sequence to open the crate.

The temperature and humidity logs, stored in memory in the controller circuit 22, provide the shipping crate the ability to monitor pharmaceuticals when in transit, even when the unit is not connected to an external power supply. If the inside of the crate 10 was at all times during shipment within a prescribed temperature window (and, if appropriate, withing a range of relative humidity), the stored program in the controller circuit 22 will output a coded signal to appear on the display 44 as a code sequence. However, if the temperature and/or humidity were out of the acceptable range during shipping, the stored program in the controller circuit provides a different code sequence that is displayed on the display 44. The controller circuit 22 and the shipper's computer are both be programmed with encrypted software to generate and recognize code sequences that identify a safe arrival of the shipment or that identify a compromised or possibly compromised shipment. When the recipient turns on the touch screen, the displayed code sequence appears. Then the recipient enters this code sequence onto the shipper's Internet web page that appears at the computer work station 36. If the code sequence represents a safe shipment, the shipper's computer recognizes this and sends back an opening code sequence. The recipient then enters this on the touch key pad 48 to actuate the lock mechanism 20 and open the lid 14 to access the pharmaceuticals inside. However, if the crate's code sequence represents a compromised shipment, i.e., when the temperature and/or humidity were outside of the safe window at some time during shipment, then when the code (shown on the display 44) is entered on the computer work station 36, the same will display a message that the crate may have been compromised and that the recipient is to send the crate back to the shipper immediately. The recipient will not be provided with an opening code sequence, and will not be able to unlock the lid and open the crate. In this way the system denies access to the crate or container holding the pharmaceuticals, to prevent the distribution of potentially tainted medication. As aforementioned, the crate 10 and its controller circuit can be connected by the USB cable 38 (or in some embodiments, wirelessly connected) with the computer work station 36 or with a local or wide area network, and the codes can be provided for identifying the quality of the shipment and for opening the lid 14 (or denying access, if that is appropriate) without needing to manually enter the displayed code sequence. The monitor screen of the computer work station 36, or hand-held device 42, will display safe arrival and success of the shipment, where the temperature and/or humidity have been maintained at safe levels. In the event that the number shown on the display 44 corresponds to a compromised shipment, the message to return the crate, unopened, back to the shipper, will appear on the screen of the work station 36 or hand-held device 42. At the same time, the fact of the compromised shipment, as well as the contents, i.e., lot number or other identifying information, is made known and can be transmitted automatically to authorities and pharmacies to prevent them from distributing compromised, and possibly unsafe, pharmaceuticals. Preferably, the shipping location will automatically generate alert messages, sent to the government authorities and to other users, identifying the crate contents with a product code, e.g., lot number and/or date codes, and a warning that such products are possibly tainted and should not be distributed or dispensed. Also, instead of the USB connection, it is possible to employ Bluetooth or another wireless system to interrogate the code when the crate arrives at the recipient location.

Similarly, it is possible to use RFID technology, with a programmable RFID code chip incorporated into the crate electronics. In the case of a normal or good shipment, the RFID chip would return one code, but if a shipment was out of temperature/humidity range, the chip would return a different coded signal to the scanner. This arrangement would require an RFID reader at the recipient site to obtain the coded information. A return of a “bad” code would then result in the shipper website responding with a “return crate to shipper” message, without sending the recipient the opening code sequence. In this case, where the signal from the RFID chip (or the Bluetooth device) indicates a normal or safe shipment, the opening code can be sent wirelessly to the crate, not requiring the operator or recipient to enter the opening code(s) manually.

One optional feature is the use of a wireless temperature/humidity sensor. This would be placed within the insulated portion of the box, and would communicate wirelessly with the electronics within the box, but external to the insulation. This would eliminate any need to puncture or perforate the insulation to pass the wired sensor(s).

The controller circuit 22 may also be programmed to keep an audit history of all persons accessing the pharmaceutical crate, as well as times of access, in addition to keeping a history of the temperature and humidity conditions at all times during transit. The temperature and humidity charts may be displayed on the local computer monitor, for example. In some embodiments, these may be displayed on the touch-screen device 26.

The crates or containers of this invention may contain ice to maintain a cool internal temperature, or may be shipped within a refrigerated container or refrigerated chamber. In that case, different size boxes may be used for different size shipments. The means for setting the lock are inside the shipping crate, and are not accessible from outside and cannot be tampered with from outside. The acceptable temperature and humidity ranges or windows can be set electronically. The logs of temperature and humidity serve as a means of creating an audit history for the shipment. The lock mechanism may incorporate an alternative means of entering an access code.

The shipping crate 10 may also be employed without the temperature and humidity features for secure shipments of narcotics or other controlled substances. When the shipment arrives at the destination, the recipient must first obtain a security-generated code, i.e., number, from the display 44 of the touch-screen device 26. This code number is then entered into the shipper website. If the code number represents a transit in which the in-transit safety conditions were acceptable, the website will return a password that allows the lock to release and allows the crate to be opened. However, if the generated code number appearing at display 44 indicates a shipment where the transport did not meet safety specifications, i.e., if there is evidence of unauthorized or forced opening, the website will notify the recipient (as well as the shipper) that the medicine is presumed tainted, and will not allow the recipient of the crate to open the container. The website also instructs the recipient as to the next step, i.e., to return the crate immediately to the pharmaceutical company. Then when the shipper receives the box in the return shipment, the shipper will be able to open the crate (using an over-ride passcode or a manual pass key) to inspect the contents.

This process as described above ensures that a secure transport chain is maintained, protecting the integrity of the medications at all times. If it turns out that the shipment without the proper safe-receipt code is not returned, or is returned with indication of damage from forced opening, the pharmaceutical company and the governmental authorities would know that a batch of medication was tainted and was still distributed and used. The company can then send out warnings to users that certain date-coded and/or lot-coded medications may be tainted and are not to be used.

In addition, at time of shipment, the information on the packing list (i.e., contents, including lot numbers) preferably can also be entered into the aforementioned website. The website would then generate a “locking” code for the container: this code would be different from the unlock code, but software in the container electronics would be able to use this to generate a unique time-sensitive unlock code which would be released from the website when the correct ID code is entered as input. This code can be entered into the container manually, or via a USB connection to an Internet-connected PC. If a faulty or incorrect ID code is entered (after some limited number of attempts) the box will need to be returned to the sender for manual unlocking. At the sender or shipper location, the USB connection can be employed for download of audit trail information, and can identify the time, location, and nature of the problem in transport.

The box itself can be fabricated of a durable plastic or metal (e.g., aluminum) to keep weight and shipping costs down. The box may contain insulation plus room for ice and the medications. Alternatively, the box may have air holes for ventilation for use in a refrigerated truck. The box may have an isolated ice or freezer pack compartment. The battery power may be from standard alkaline batteries, or from rechargeable cells, which may potentially be recharged via the USB connection.

This shipping box with lock achieves control over the transport chain, using Internet access. By mandating proper entry of a code to a secure website, with the user being unable to open the box without accessing this website, the box and lock guarantees reporting of improper transport and possibly tainted medications. The timing of the input also helps assure that the medication was delivered in timely fashion, and that there were no shipping delays in transit where the product was unrefrigerated.

The lock of this invention can also be used in shipping of controlled materials, e.g., narcotics, where temperature and humidity do not need to be monitored, but where it important to ensure against tampering or unauthorized openings of the cabinet. In this case, there is an internal battery power supply, and the control circuit incorporates suitable software with a provision for accepting an opening code from an authorized user so as to enable the lock mechanism to move and release the latch 20 from engagement, so that the crate 10 can be opened. Also, the software which includes an audit trail provision for recording a history of the times and identities of person(s) opening the cabinet. The contents encoded within the controller circuit 22 can be downloaded via the USB port 24, to identify whether there has been tampering or unauthorized opening of the cabinet. When the recipient returns the displayed code to the shipper (e.g., via Internet) the correct opening code for the lock is sent to the recipient only if there has been no tampering and no unauthorized openings. Then, the authorized recipient can open the cabinet. However, if the displayed code indicates that the tampering or unauthorized opening has occurred, the shipper will not provide the opening code, but instead will provide instructions to secure and/or return the cabinet. The shipper software can be programmed to automatically inform the appropriate government authorities of a possibly compromise of the controlled substance.

In some cases, a lock would not be used but the lid would be secured shut during shipment. The monitoring and notification features would be retained, for example in the transport of “biologicals”—transplant organs. In this case, the receiving surgeon should be able to confirm the status of shipment conditions, but the recipient is not prevented from using the transplant organ if the surgeon determines, upon inspection, that the organ is acceptable.

While the invention has been described hereinabove with reference to selected preferred embodiments, it should be recognized that the invention is not limited to those precise embodiments. Rather, many modification and variations would present themselves to persons skilled in the art without departing from the scope and spirit of this invention, as defined in the appended claims.

I Claim:

1. A locking shipping crate for holding sensitive materials as its contents and identifying whether the contents thereof have been compromised before allowing the recipient access to said contents; said shipping crate comprising
a body in which said sensitive materials are to be stored and shipped;
a lid which closes against said body;
a lock mechanism for securing the lid closed on the body;
suitably programmed circuit means for controlling said lock mechanism;
said circuit means including means providing a coded sequence representing a safe condition for said contents and providing a different coded sequence representing a compromised conditions of said contents based on conditions of said shipping crate during transit; and
means for accepting an opening code which, when input into said circuit means, causes the same to open release said lock so that said lid can be opened for access to said contents.

2. The locking shipping crate according to claim 1, further comprising a temperature monitor having a probe sensing temperature inside said body during transit; and said suitably programmed circuit means being connected to said probe and providing said coded sequence based on temperature received from said temperature monitor.

3. The locking shipping crate according to claim 1, further comprising a humidity monitor having a probe sensing a humidity level inside said cabinet, the monitor being coupled with said suitably programmed circuit means for communicating said humidity level thereto.

4. The locking shipping crate according to claim 1, further including software which includes audit trail means for recording time of opening of the lock mechanism and also recording identity of each requesting person associated with such openings of the lock mechanism.

5. The locking shipping crate according to claim 1, further comprising display means for displaying an open/closed state of said lock mechanism.

6. The locking shipping crate according to claim 1, wherein said suitably programmed circuit means includes audit trail software for recording a time history of temperature of the inside of said shipping crate during transit.

7. The locking shipping crate according to claim 1, wherein said suitably programmed circuit means includes audit trail software for recording a time history of humidity inside said shipping crate during transit.

8. The locking shipping crate according to claim 1, wherein suitably programmed circuit means includes a USB interface.

9. The locking shipping crate according to claim 1, comprising a control and display interface device which includes keypad buttons thereon for entering data, and a display area showing at least said coded sequences.

10. The locking shipping crate according to claim 1, wherein said display and control interface device is mounted on said lid.

11. The locking shipping crate according to claim 10, wherein said display and control interface device includes a membrane switch.

12. The locking shipping crate according to claim 1, wherein said lock mechanism includes a manual lock override permitting authorized persons to unlock said lid with a key.

13. A method of safe shipment of a quantity of a sensitive material in a locking shipping crate from a shipping location to a receiving location, in which the locking shipping crate includes:
a body in which sensitive materials are to be stored and shipped;
a lid which closes against said body;
a lock mechanism for securing the lid closed on the body;
suitably programmed circuit means for controlling said lock mechanism;
said circuit means including means providing a coded sequence representing a safe condition for said contents and providing a different coded sequence representing a compromised conditions of said contents based on conditions of said shipping crate during transit; and
means for accepting an opening code which, when input into said circuit means, causes the same to open release said lock so that said lid can be opened for access to said contents;
the method comprising:
sending the crate from said shipping location to said receiving location;
at said receiving location, obtaining from said crate said coded sequence and transmitting same to said shipping location;
where said coded sequence represents a safe condition of the contents of said crate, said shipping location transmitting to said receiving location said opening code; and at said receiving location, entering said opening code into the suitably programmed circuit means to open the lid of said shipping crate; but
where said coded sequence represents a compromised condition of the contents of the shipping crate, said shipping location transmitting to said receiving location a message denying said opening code and instructions for safe disposition of said shipping crate and the contents thereof.

14. The method of claim 13, further comprising providing, from said suitably programmed circuit means, an audit trail history of the conditions of said crate during transit.

15. The method of claim 14, wherein said audit trail history includes a time record of temperature within said shipping crate during transit.

16. The method of claim 14, wherein said audit trail history includes a time record of humidity within said shipping crate during transit.

17. The method of claim 13, wherein a computer processor at said shipping location and the suitably programmed circuit means of said crate each include encryption software for changing said opening code over time.

18. The method of claim 13, further comprising, in the case in which the coded sequence represents a compromised condition, said shipping location automatically generating alert messages, identifying the contents of said crate by product code, that such contents are possibly compromised and are not to be used.

19. A method of safe shipment of a sensitive item in a shipping crate from a shipping location to a receiving location, in which the locking shipping crate includes:
a body in which sensitive materials are to be stored and shipped;
a lid which closes against said body;
means for securing the lid closed on the body;
suitably programmed circuit means providing a coded sequence representing a safe condition for said contents and providing a different coded sequence representing a compromised conditions of said contents based on conditions of said shipping crate during transit; and
means for accepting an input code sequence;
the method comprising:
sending the crate from said shipping location to said receiving location;
at said receiving location, obtaining from said crate said coded sequence and transmitting same to said shipping location;
where said coded sequence represents a compromised condition of the contents of the shipping crate, said shipping location transmitting to said receiving location a message providing a possible compromise message to the recipient; and
said recipient inspecting the sensitive item to determine its fitness for use.
